(19) United States
(12) Patent Application Publication
(10) Pub. No.: US 2026/0246560 A1
(43) Pub. Date: Aug. 20, 2026

(54) LATENCY ANNOUNCEMENT BY ACCESS POINT

(71) Applicant: Cisco Technology, Inc., San Jose, CA (US)

(72) Inventors: Alan W. Dumdei, Greenville, TX (US); Malcolm M. Smith, Richardson, TX (US); Binita Gupta, San Diego, CA (US)

(21) Appl. No.: 19/249,171

(22) Filed: Jun. 25, 2025

Related U.S. Application Data
(60) Provisional application No. 63/759,778, filed on Feb. 18, 2025.

(51) Int. Cl. H04L 1/00; H04W 76/15

(52) U.S. Cl. CPC H04L 1/0018; H04W 76/15

(57) ABSTRACT

Presented herein are techniques to enable a client to identify a suitable link based on latency considerations when configuring an access point (AP). In one embodiment, a method includes determining at least one latency indication associated with a network element, the at least one latency indication including a plurality of statistics indicative of a latency associated with at least a first link supported by the network element. The method also includes causing the at least one latency indication to be provided in a message to a client, and obtaining a request from the client in response to the at least one latency indication.

### PRIORITY CLAIM

This patent application claims the benefit of priority under 35 U.S.C. § 119 to U.S. Provisional Patent Application No. 63/759,778, filed Feb. 18, 2025, and entitled “PRE-ASSOCIATIVE LATENCY ANNOUNCEMENT,” which is incorporated herein by reference in its entirety.

### TECHNICAL FIELD

The present disclosure relates to wireless networks.

### BACKGROUND

In a wireless network such as an IEEE 802.11 wireless network, an access points (AP) such as a wireless access point (WAP) enables wireless devices to connect to a wired network. For example, an AP may enable a device such as a smartphone or a computer to connect to a wired network.

APs have multiple frequency bands that support wireless communications, as for example Wi-Fi® wireless network communications. A frequency band or Wi-Fi band is a broadcast frequency range within which a device may operate to send and to receive data. For example, APs may generally operate in a 2.4 GigaHertz (GHz) frequency band, a 5 GHz frequency band, and a 6 GHz frequency band. In general, a higher frequency band may support higher speeds, but may have a reduced broadcast range.

While a 6 GHz band is generally less congested than a 5 GHz band due, for example, to the availability of more channels, many users utilize 5 GHz bands rather than 6 GHz bands when configuring APs. The use of a 5 GHz band when a 6 GHz band is available on an AP may result in a wireless client sacrificing a better overall network experience for a stronger signal, which may have an adverse effect on performance.

### BRIEF DESCRIPTION OF THE DRAWINGS

FIG. 1A is a diagrammatic representation of a network that includes access points (APs) that server wireless clients using the techniques presented herein.

FIG. 1B is a diagrammatic representation of an access point that is an AP multi-link device (AP MLD) and a client device, e.g., access point 138a and device 142 of FIG. 1A, which may communicate on multiple bands.

FIG. 2 is a diagrammatic representation of an AP MLD, e.g., AP MLD 138a′ of FIG. 1B.

FIG. 3 is a diagrammatic representation of an AP MLD e.g., AP MLD 138a′ of FIG. 1B, in accordance with an embodiment.

FIG. 4A is a process flow diagram which illustrates a method of providing an indication of latency to a client in accordance with an embodiment.

FIG. 4B is a process flow diagram which illustrates a method of calculating at least one value that indicates a probability of achieving a measured latency, e.g., step 405 of FIG. 4A, in accordance with an embodiment.

FIG. 5 is a process flow diagram which illustrates a method of processing an indication of latency by a client in accordance with an embodiment.

FIG. 6 is a diagrammatic representation of a process of selecting a link based on a latency indication in accordance with an embodiment.

FIG. 7 is a diagrammatic representation of messages that include latency information which are provided to a client in accordance with an embodiment.

FIG. 8 is a diagrammatic representation of latency information in accordance with an embodiment.

FIG. 9 illustrates a hardware block diagram of a computing device that may perform the functions of a client and/or an access point in connection with the techniques depicted in FIGS. 1A, 1B, 2, 3, 4A, 4B, and 5-8.

### DESCRIPTION OF EXAMPLE EMBODIMENTS

### Overview

Presented herein are techniques to enable a client, as for example a Wi-Fi client, to identify pre-association suitable frequency bands or links of an access point multi-link device (AP MLD) and/or to identify the AP MLD or an AP, itself, for performing association or multi-link setup based on latency considerations experienced at the AP or the affiliated APs of the AP MLDs. By defining one or more latency elements that provides an indication of measured latency experienced on a frequency band or link of an AP to a client, or on the frequency band or link of an affiliated AP of an AP MLD to a client, the client may select a frequency band or link for association and/or later transmitting and receiving data based on a desired client experience. The indication of measured latency may effectively be a representation of client experience for the particular band, and may facilitate a selection of an appropriate band or link and, hence, an appropriate AP based on a desired client experience.

One or more latency elements that provide an indication of measured latency experienced by an AP may also be utilized by a client that has previously been associated with an AP or AP MLD to achieve desired latency performance for its traffic flows by selecting one or more associated links that provide latency measurements desired for the traffic flows. That is, latency indications may be used both pre-association and post-association. The latency measurements may also enable a client to determine when to add more links to a multi-link setup or configuration. For example, if a client determines that another link of a current AP MLD provides better latency measurements than a current link, and the client has low latency flows, then the client may dynamically add that link to its multi-link setup substantially without performing a reassociation.

One or more latency elements that provide an indication of measured latency experienced by an AP may, additionally or alternatively, be provided to the client from its current serving AP or AP MLD for its one or more neighboring APs or affiliated APs of the neighboring AP MLDs. The latency information of neighboring APs or AP MLDs may enable a client to effectively make a better or otherwise improved selection of a roaming candidate when performing roaming. The one or more latency elements for neighboring APs or AP MLDs may be provided, for example, in a neighbor report element in the one or more of neighbor report response frames, a basic service set transmission management (BTM) request frame, and/or a probe response frame.

Latency information associated with a network element such an AP or an affiliated AP of an AP MLD may include a plurality of statistics indicative of latency on a link of the AP or on each link of the AP MLD. It should be appreciated that a link of an AP MLD operates on a particular frequency band, and multiple links of the AP MLD may operate on the same or different frequency bands. For example, an AP MLD may include more than one link associated with a particular frequency band.

According to one embodiment, a method includes determining at least one latency indication associated with a network element, the at least one latency indication including a plurality of statistics indicative of a latency associated with at least a first link supported by the network element. The method also includes causing the at least one latency indication to be provided in a message, the message configured to be provided to a client, and obtaining a request from the client in response to the at least one latency indication.

In another embodiment, an apparatus includes a first network element and a second network element. The first network element is associated with a first link. The apparatus also includes a processor and logic, when executed by the processor, operable to determine at least one latency indication associated with at least one of the first network element and the second network element, the at least one latency indication including a plurality of statistics indicative of a latency associated with at least the first link, and cause the at least one latency indication to be provided in a message, the message configured to be provided to a client. The apparatus further includes a communications arrangement, the communications arrangement configured to obtain a request from the client in response to the at least one latency indication.

In accordance with still another aspect, one or more non-transitory computer readable storage media encoded with instructions, that when executed by a processor, cause the processor to perform determining at least one latency indication associated with a network element, the at least one latency indication including a plurality of statistics indicative of a latency associated with at least a first link supported by the network element, and causing the at least one latency indication to be provided in a message, the message configured to be provided to a client. The instructions are further operable to cause the processor to perform obtaining a request from the client in response to the at least one latency indication.

### Example Embodiments

In wireless networks with APs that support multiple links across one or more frequency bands, e.g., AP multi-link devices (AP MLDs), a client may generally identify a link operating on a frequency band associated with an AP that may be used to send and to receive data. An AP MLD may include multiple links which operate on substantially the same frequency band, although in some embodiments, the AP MLD may include one link per frequency band. Typically, a client may select a link with a stronger signal, as for example based on a received signal strength indicator (RSSI) and/or a bit error rate (BER). When links include a 5 GigaHertz (GHz) link and a 6 GHz link, the stronger signal will generally be associated with the 5 GHz link. However, regardless of signal strength, better performance may generally be provided by the 6 GHz link due to the lower latency generally associated with the 6 GHz link when compared with the 5 GHz link. As such, when a client selects a 5 GHz link based on signal strength, the client may not be selecting the link with better latency performance.

Latency information such as a latency indication may be processed pre-association and post-association. In one embodiment, during pre-association, a client may effectively consider a latency indication the client obtains from one or more APs or AP MLDs to identify the AP or AP MLD that the client selects to associate with. In another embodiment, during post-association, a client may use a latency indication to identify a most suitable link to use for its traffic flows to meet a desired latency, e.g., to meet latency requirements. Post-association, the client may also use a latency indication from APs of an associated AP MLD to determine whether to add other links to its association, in an effort to achieve improved latency performance for its traffic flows. In still another embodiment, during post-association, a client may obtain a latency indication for its neighboring APs or AP MLDs either through its current AP MLD or substantially directly by scanning neighboring APs. Once obtained, the client may use the latency indication of those neighboring AP MLDs as a criterion to determine a suitable roaming candidate to roam to based on the latency requirements of its traffic flows.

By providing information that indicates a client experience for each link supported by an AP MLD, a client may be able to select a link for use to send and to receive data based on the latency experienced for each link. In one embodiment, a relatively lightweight element may be provided that effectively represents a latency associated with each link. e.g., with particular frequency bands. Such an element may be provided in various Wi-Fi network broadcast elements such that an indication of a measured latency currently experienced in a particular basic service set (BSS) is accessible in the Wi-Fi network broadcast elements. The element may allow a client to essentially determine, or otherwise identify, an AP and/or a link to select such that a lower amount of latency may provide a more suitable client experience as the client makes roaming decisions, rather than the client making a decision relating to an AP and/or link to use based substantially only on a strongest signal. As will be appreciated by those skilled in the art, roaming generally involves the client moving between APs that advertise a suitable wireless network. In one embodiment, the client may make a roaming decision by effectively scanning available, suitable wireless networks to determine which wireless network to connect to, e.g., based at least in part on latency considerations associated with links of an AP or AP MLD in the wireless network.

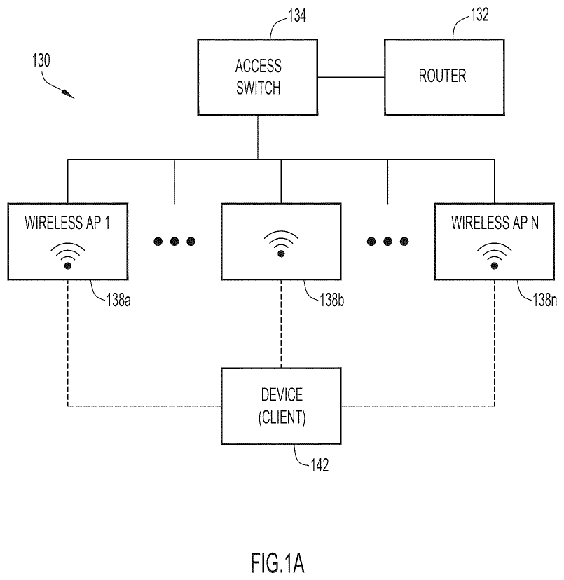

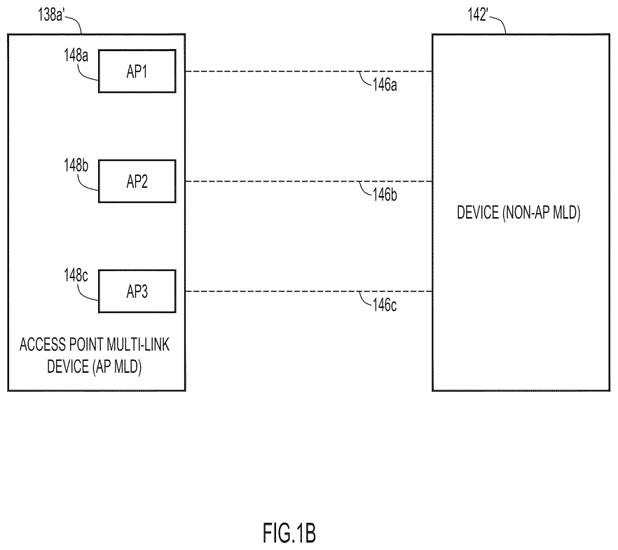

FIG. 1A is a diagrammatic representation of a network that includes AP or AP MLDs. A network 130 includes network elements such as a router 132, an access switch 134, and APs 138a-n. The number of APs 138a-n that are in communication, e.g., communication through wired links, within network 130 may vary widely. A device 142, which may be a communication device such as a station (STA) also called “client”, may communicate wirelessly with AP 138a, AP 138b, and/or AP 138n as appropriate. For example, as device 142 moves or roams within network 130, device 142 may communicate with different APs 138a-n. APs 138a-n may each be capable of supporting different links, and may each select a particular link to support with respect to device 142. That is, APs 138a-n may be AP MLDs that may support device 142, which may be a non-AP MLD

Referring next to FIG. 1B, communication between AP 138a when AP 138a is an AP MLD and device 142 will be described. AP MLD 138a′ may communicate with device 142′, which may be a non-AP MLD. Multi-link operation enables aggregation of multiple links 146a-c or channels, which may each be associated with an AP affiliated with, or otherwise included in, AP MLD 138a′. That is, AP MLD 138a′ include a first AP 148a or AP STA associated with link 146a, a second AP 148b or AP STA associated with link 146b, and a third AP 148c or AP STA associated with link 146c.

Through multi-link operation, AP MLD 138a′ and device 142′ may associate and exchange traffic on at least one of links 146a-c. Links 146a-c include, but are not limited to including, links which may be 5 GHz, 6 GHz, and/or a 2.4 GHz links.

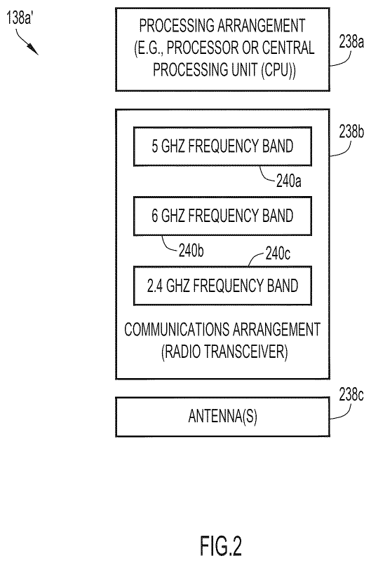

With reference to FIG. 2, an AP MLD such as AP MLD 138a′ of FIG. 1B that is arranged to communicate within a network such as network 130 will be described in accordance with an embodiment. AP MLD 138a′ includes a processing arrangement 238a, a communications arrangement 238b, one or more antennas 238c. Processing arrangement 238a may generally be a central processing unit (CPU) and associated supporting components (memory that stores instructions to be executed, etc.). Communications arrangement 238b may include a radio transceiver and one or more baseband signal processors (modems). Typically, communications arrangement 238b may be arranged to enable AP MLD 138a′ to communicate wirelessly and/or over wired links.

As shown, communications arrangement 238b supports links 240a-c, and one or more frequency or Wi-Fi bands. A 5 GHz link 240a, a 6 GHz link 240b, and a 2.4 GHz link 240c are supported by communications arrangement 238b such that AP MLD 138a′ may communicate on a network using any of links 240a-c. It should be appreciated that although specific frequencies of frequency bands are shown, links 240a-c are not limited to being associated with the frequencies shown, and the frequencies shown are indicated for purposes of illustration. Each link 240a-c may be associated with an AP (not shown) that is affiliated with, or otherwise associated with, AP MLD 138a′. AP MLD 138a′ may generally support multiple links operating in the same frequency band, or may alternatively support approximately one frequency band. For example, in lieu of supporting links 240a-c with frequencies discussed above, AP MLD 138a′ may instead support two links over 5 GHz and 6 GHz bands, or two links which each operate over a 6 GHz band. Further, it should be understood that AP MLD 138a′ supports one or more affiliated APs (not shown) with each affiliated AP operating on a link 240a-c.

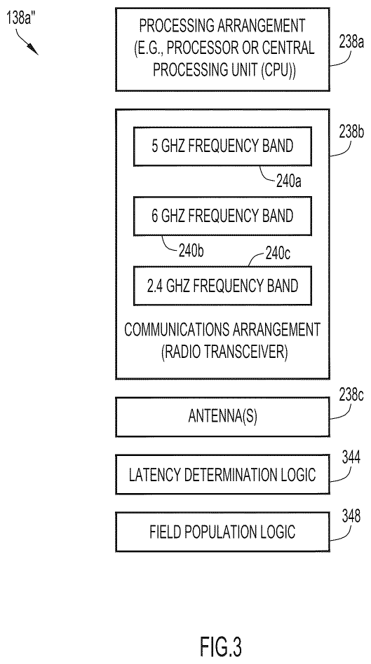

An AP MLD such as AP MLD 138a′ may include logic, as for example hardware and/or software logic which enables the AP MLD to determine a latency associated with one or more links of its affiliated PAs, and to populate one or more fields for transmission with the information that is indicative of the latency. FIG. 3 is a block diagram representation of one embodiment of AP MLD 138a′ that is configured to determine latency and to populate at least one lightweight element in a broadcast message. An AP MLD 138a″ includes processing arrangement 238a, communications arrangement 238b, at least one antenna 238c, latency determination logic 344, and field population logic 348.

Latency determination logic 344 is configured to determine a latency associated with each link, as for example 5 GHz link 240a, 6 GHz link 240b, and/or 2.4 GHz link 240c that are part of communications arrangement 238b. It should be appreciated, that as previously mentioned, the frequencies associated with links 240a-c may vary, e.g., two or more links 240a-c may have substantially the same frequency. Latency determination logic 344 may measure latency and represent the latency as a cumulative distribution function (CDF) and/or one or more latency CDF percentiles for each link 240a-c. As will be appreciated by those skilled in the art, a CDF may determine a probability that a variable, as for example a latency, may be less than or approximately equal to a particular value. A latency CDF generally specifies the probability that a latency is less than or approximately equal to a particular value. A latency CDF is used to determine the percentiles of latency distribution, e.g., a latency CDF may provide a ninety-fifth percentile latency value which indicates that approximately ninety-five percent of the measured latencies were less than or equal to that value. Similarly, latency CDF may provide a seventy-fifth percentile latency value which indicates that approximately seventy-five percent of the measured latencies were less than or equal to that value.

An indication of the measure of latency, as for example one or more latency CDF percentile values, may be added to an appropriate element or field of a broadcast transmission by field population logic 348. By way of example, at least one indication of the measure of latency may be added to, but is not limited to being added to, a beacon, a probe response, a multi-link (ML) probe response, a fast initial link setup (FILS) discovery frame, a neighbor report response, and/or a BSS transmission management (BTM) request by field population logic 348. Field population logic 348 may add the latency measurement indication to a reduced neighbor report (RNR) element, a BSS load element, a neighbor report element, or another new or existing element in these frames. It should be appreciated, however, that AP MLD 138a″ may either directly add at least one indication of a measure of latency to a broadcast transmission or may provide at least one indication to a network element (not shown) that may add at least one indication of a measure of latency to a broadcast transmission. A client may be able to make roaming decisions to select a suitable roaming candidate AP or AP MLD based upon obtaining or otherwise receiving at least one indication of the measure of latency from its neighboring APs or AP MLDs. In other words, the client may consider a latency measurement indication obtained for neighboring APs or affiliated APs of neighboring AP MLDs as a factor in selecting AP MLD 138a″ and/or a frequency band or link associated with AP MLD 138a″ as an AP or AP MLD to which to roam.

Once a client selects a link 240a-c, communications arrangement 238b may cause a connection to be established between the client and an AP associated with the selected link 240a-c. For example, in response to a connection request obtained from a client, communications arrangement 238b may effectuate a connection between the client and AP MLD 138a″ using the link 240a-c selected by the client. It should be appreciated that the selected link 240a-c may generally be included in the connection request.

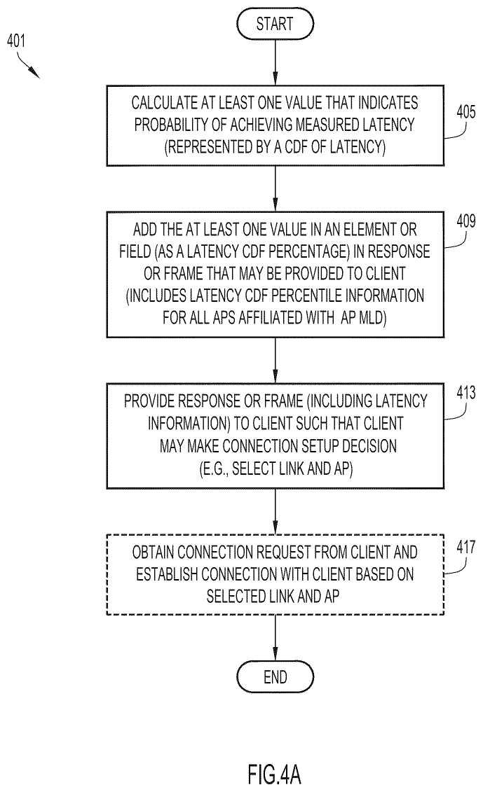

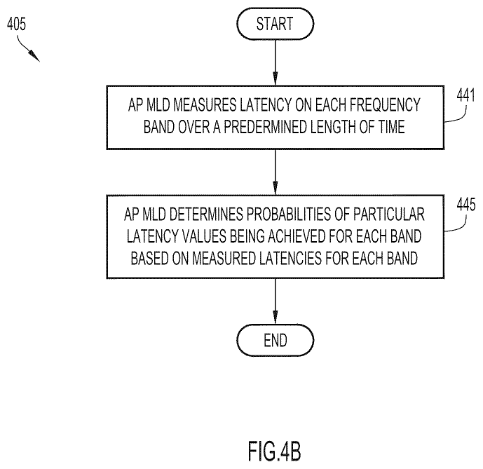

In general, a method of adding one or more values that indicate a probability of achieving a measured latency may vary for each Wi-Fi router supported for IEEE 802.11ac access category (AC) or traffic identifier (TID). In one embodiment, one or more values that indicate a probability of achieving a measured latency may be provided for each link supported by an AP MLD. FIG. 4A is a process flow diagram which illustrates one method of providing an indication of latency to a client in a network that includes at least one AP MLD in accordance with an embodiment. A method 401 of providing an indication of latency to a client begins at a step 405 in which at least one value that indicates a probability of achieving a measured latency is calculated by an AP MLD that is a network element within a wireless network. The one or more values may be represented by a CDF of latency and/or a latency CDF percentage. One method of calculating at least one value that indicates a probability of achieving a measured latency will be discussed below with respect to FIG. 4B.

In a step 409, the one or more values are added to an element or a field, e.g., as a latency CDF percentage, in a response or a frame, e.g., a message, that may be provided to the client. The latency CDF percentile information for substantially all APs or links affiliated with the AP MLD may be provided to the client.

Once values are added in an element or a field or a response or a frame, the response or frame is provided to a client in a step 413. The client may use the values to make a connection set up decision, e.g., to select a link and/or an AP for use. By way of example, the client may make a decision on which link to select for connection setup based at least in part on an expected Quality of Service (QoS) experience indicated by the values.

After the response or frame is provided to the client, process flow proceeds to a step 417 in which a connection request is obtained from the client by an AP MLD, and a connection between the client and an AP affiliated with the AP MLD is established in an optional step 417. The connection is typically established on a link, and with an AP selected by the client. Upon establishing the connection, the method of providing an indication of latency to a client is completed. Establishing a connection is described as part of a method of providing an indication of latency to a client for purposes of illustrating the use of the indication of latency, although it should be appreciated that a latency indication may be provided even if not utilized or otherwise processed.

With reference to FIG. 4B, one method of calculating at least one value that indicates a probability of achieving a measured latency, e.g., step 405 of FIG. 4B, will be described in accordance with an embodiment. Method or step 405 begins at a step 441 in which an AP MLD measures latency. In one embodiment, the AP MLD performs a substantially continuous measurement of latency experienced by MAC Service Data Units (MDSUs) on each link or BSS of affiliated APs of the AP MLD. In such an embodiment, the AP MLD, or each affiliated AP of the AP MLD, measures the latency on a BSS level based on MSDUs delivered across substantially all associated STAs on an associated link. The AP MLD then determines CDF percentile of latency over a predetermined length of time as indicated by a first duration. For example, the AP MLD determines 95^{th} percentile, 90^{th} percentile, 75^{th} percentile and 50^{th} percentile of CDF latency for each link. Latency CDF information may be measured over a first duration, and may be periodically updated in broadcast frames and/or unicast frames sent to clients) when a second duration has elapsed. The first duration and the second duration may both be, in one embodiment, on the order of hundreds of milliseconds long, although it should be appreciated that the first duration and the second duration may also be quite different. It should be appreciated that each affiliated AP will typically generate its own latency measurements, with the generation of latency measurements effectively being at the AP level and this can be coordinated by the AP MLD. After the AP MLD measures latency on each link continuously, the AP MLD determines probabilities of particular latency values being achieved for each link in a step 445 based on the measured latencies for each link. For example, probabilities may be determined as latency CDF percentile values that correspond to 50th percentile, 75th percentile, 90th percentile, and 95th percentile. The method of calculating at least one value is completed upon the AP MLD determining probabilities of particular latencies.

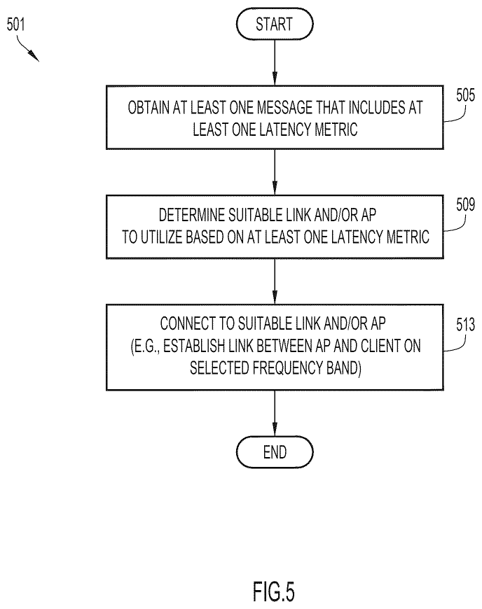

Referring next to FIG. 5, a method of processing an indication of latency received by or otherwise obtained in a latency announcement by a client will be described in accordance with an embodiment. The latency may be obtained either pre-association or post-association. A method 501 of processing an indication of latency begins at a step 505 in which a client, e.g., a STA or a non-AP MLD, obtains at least one message that includes at least one latency metric or, more generally, at least one indication of latency. The message is obtained from one or more links of an AP MLD. It should be appreciated that a message obtained from one link may provide a latency indication substantially only for that link, or may provide latency indications for multiple links of that AP MLD. The message that includes a latency indication may be provided, broadcast or directly sent to the client, by the affiliated APs of the AP MLD. In one embodiment, a latency indication may be provided by an AP for neighboring APs or neighboring AP MLDs. The latency indication for neighboring APs may be provided as part of an element that provides neighbor AP information such as a Neighbor Report element. The latency indication for neighboring APs may be provided in an individually addressed frame or a broadcast frame sent to the client such as a BTM Request frame or a Neighbor Report Response frame.

In a step 509, the client determines or otherwise identifies a suitable frequency band/link and/or AP to connect to based on at least one latency metric. As mentioned above, latency information such as a latency indication or metric may be processed pre-association and post-association. During pre-association, when the client is not associated with the AP, the client may utilize a latency metric to identify the AP or AP MLD that the client selects to associate with. During post-association, the client that is already associated with an AP MLD may use the latency metric to identify a more suitable link to use for its traffic flows to meet a desired latency, e.g., a more suitable link of the same AP MLD that the client has already set up with that AP MLD that provides improved latency performance based on a latency metric. Further, during post-association, the client may also use a latency metric from APs of an associated AP MLD to determine whether to add other links to its association, in an effort to achieve improved latency performance for its traffic flows. In one embodiment, during post-association, the client may obtain a latency metric for its neighboring APs or AP MLDs and use the latency indication of those neighboring AP MLDs as a criterion to determine a suitable roaming candidate to roam to based on the latency requirements of its traffic flows. For example, a client may obtain a latency metric for one or more of its neighboring APs in a BTM Request frame, or in a Neighbor Report Response frame, or as part of a Neighbor Report (NR) element and then use the latency metric for neighboring APs to select a candidate neighboring AP to roam to that may meet latency requirements for its current traffic flows.

After the client determines a suitable frequency band and/or AP to connect, process flow moves to a step 513 in which a connection is made between a suitable link and/or an AP. That is, a link is established between the AP and the client on a selected frequency band. Once the link is established, the method of processing an indication of latency is completed.

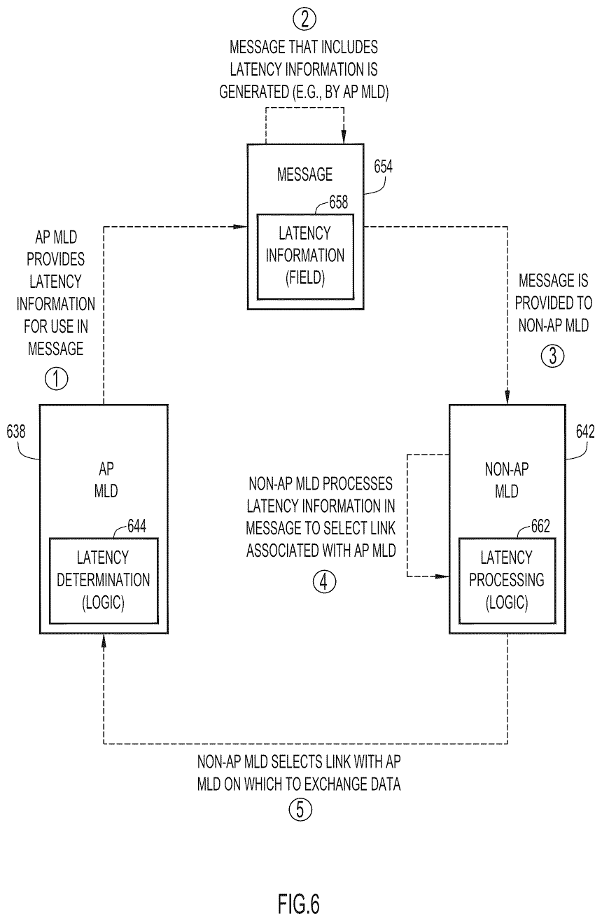

FIG. 6 is a diagrammatic representation of a process of a client such as a non-AP MLD selecting a link of an AP MLD to use based on a latency indication associated with a frequency band associated with an AP MLD in accordance with an embodiment. An AP MLD 638 includes latency determination logic 644 which enables AP MLD 638 to generate at least one latency indication, or latency information 658. Latency information 658 may include, but is not limited to including, latency statistics which provide latency CDF percentile information for one or more frequency bands supported by AP MLD 638, e.g., substantially all frequency bands supported by AP MLD 638.

A non-AP MLD 642 may generally include latency processing logic 662, or hardware and/or software configured to enable non-AP MLD 642 to process latency information 658. When latency information 658 such as latency statistics are processed by latency processing logic 662, non-AP MLD 642 may make decision, to select a link on which to transmit or receive with AP MLD 638 based at least in part on latency considerations. That is, non-AP MLD 642 may select an AP affiliated with AP MLD 638 to effectively exchange data (or control information) based at least in part on latency considerations.

At a time t1 (denoted by “1” in a circle), AP MLD 638 provides latency information that may be included in a message 654. Providing latency information may generally include, but is not limited to including, calculating latency statistics or metrics such as one or more latency CDF percentile values using latency determination logic 644.

At a time t2 (denoted by “2” in a circle), a message 654 is generated that includes latency information 658 stored in one or more element/fields/subfields of message 654. Message 654 is typically generated by one or more affiliated APs of AP MLD 638, but coordinated by AP MLD 638. However, message 654 may instead be generated by AP MLD 638 rather than by individual affiliated APs of the AP MLD 638. In one embodiment, the latency information may also be generated by an AP that is not affiliated with an AP MLD.

Once message 654 is generated, message 654 may be provided to non-AP MLD 642 at a time t3 (denoted by “3” in a circle). Message 654 may be broadcasted such that message 654 may be obtained by non-AP MLD 642, or message 654 may be sent unicast to non-AP MLD 642, e.g., in response to a request from non-AP MLD 642 or sent unsolicited to the non-AP MLD.

At a time t4 (denoted by “4” in a circle), non-AP MLD 642 processes latency information 658 obtained in message 654 using latency processing logic 662. Processing latency information 658 enables non-AP MLD 642 to select a link (or links) associated with AP MLD 638 based, at least in part, on latency information 658. It should be appreciated that link selection at non-AP MLD 642 for communication with AP MLD 638 may involve selecting more than one link based on latency information 658. For example, if non-AP MLD 642 is a dual radio device, then non-AP MLD 642 may communicate on two links substantially simultaneously.

After non-AP MLD 642 processes latency information 658 to select a frequency band, non-AP MLD 642 selects a link associated with AP MLD 638 at a time t5 (denoted by “5” in a circle). The selection of the link on a selected frequency band may occur either pre-association or post-association.

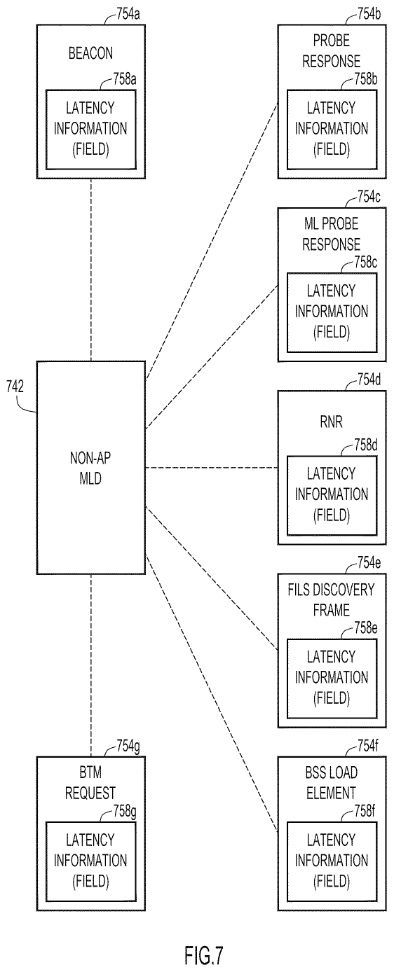

With reference to FIG. 7, messages that include latency information associated with an AP MLD which are provided to a non-AP MLD will be described in accordance with an embodiment. A non-AP MLD 742 may obtain or otherwise received one or more messages 754a-g, or Wi-Fi broadcast elements, which are configured to include latency information 758a-g, respectively. In general, latency information 758a-g may be provided as one or more metrics in at least one lightweight element, field, or subfield in various to provide an indication of measured latency experienced in a particular BSS. Such a lightweight element, field, or subfield may be provided substantially anywhere within each message 754a-g or broadcast. As previously mentioned, latency information 758a-g contained or otherwise provided in messages 754a-g allows a client such as non-AP MLD 742 to identify a particularly suitable AP or link to select based in part on client experience in lieu of, or in addition to, making such a determination based on signal strength. For example, metrics or statistics included in latency information 758a-g may facilitate enabling non-AP MLD 742 to determine AP MLD (not shown) is providing better latency across its set of affiliated APs, and to use that determination to select a preferred target AP to roam to.

A message 754a may be a beacon that includes latency information 758a. As will be appreciated by those skilled in the art, a beacon is a data packet that is sent on a network at substantially predetermined intervals by an AP or AP MLD (not shown) to provide information to devices such as non-AP MLD 742 that are within a communications range of the AP or AP MLD. Message 754a may include a service set identifier (SSID) for a network within which message 754a is sent, information which identifies links associated with the AP or AP MLD (not shown) which generated message 754a, and latency information 758a associated with the links. Latency information 758a may be stored in any suitable field within message 754a, as for example in a new field or new subfield.

A message 754b may be a probe response that includes latency information 758b. While roaming, non-AP MLD 742 may send a probe request while roaming to discover available APs or AP MLDs (not shown). In response to obtaining a probe request, an AP or AP MLD (not shown) may send message 754b or a probe response to provide non-AP MLD 742 with information which may include a SSID, information about links associated with the AP or AP MLD, and latency information 758b associated with the links. Latency information 758b may be stored in any suitable field within message 754b, as for example in a new field or new subfield.

A message 754c may be a ML probe response that includes latency information 758c. A ML probe response which may be provided to non-AP MLD 742 by an AP or AP MLD (not shown) in response to a ML probe request, may include information regarding substantially all links supported by the AP or AP MLD. Latency information 758c may be stored in any suitable field within message 754c, as for example in a new field or a new subfield. An ML probe response may provide non-AP MLD 742 with latency information for substantially all the APs of a particular AP MLD (not shown).

A message 754d may be a RNR that includes latency information 758d. A RNR initiated or otherwise provided by an AP (not shown) generally provides information related to one or more neighboring APs. For example, a first AP included in an AP MLD (not shown) may generate a RNR that provides information about a second AP included in the AP MLD. A RNR may include, in one embodiment, an identifier which identifies a neighboring AP, a SSID, a link associated with the neighboring AP, and latency information 758d that may be stored in any suitable field within message 754d, as for example a new field or a new subfield.

A message 754e may be a FILS discovery frame that includes latency information 758e. A FILS discovery frame may include an SSID, as well information pertaining to one or more links supported by an AP or AP MLD (not shown). Latency information 758e may be stored in any suitable field within message 754e, as for example in a new field or new subfield.

A message 754f may be a BSS load element that includes latency information 758f. A BSS load element may generally provide information associated with the utilization of a link, and may be generated by an AP or AP MLD (not shown). Latency information 758f may be stored in any suitable field within message 754f, as for example in a new field or new subfield such as a field provided substantially specifically for latency statistics.

A message 754g may be a BTM request that includes latency information 758g. A BTM request may provide information to non-AP MLD 742 about one or more recommended BSSs to which non-AP MLD 742 may connect. Latency information 758g may be stored in any suitable field within message 754g, as for example in a new field or new subfield.

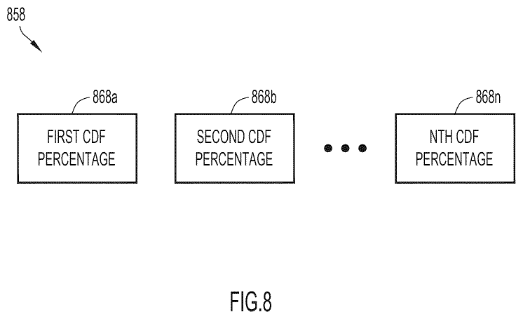

Latency information such as latency information 758a-g may be stored in a variety of different configurations. As previously mentioned, latency information may be stored as one or more latency CDF percentages or percentiles. FIG. 8 is a diagrammatic representation of latency information in accordance with an embodiment. Latency information 858, as shown, is associated with one particular link for ease of illustration, although it should be appreciated that latency information may generally include information associated with multiple links. For example, latency information 858 may indicate latency information for a single link associated with an AP or AP-MLD.

Latency information 858 may include a plurality of CDF percentages 686a-n. By way of example, latency information 858 may include a first CDF percentage 868a, a second CDF percentage 868b, and an Nth CDF percentage 868n. The number of CDF percentages 868a-n may vary widely. In one embodiment, CDF percentages 868a-n may be such that first CDF percentage 868a is a CDF percentage associated with an approximately fiftieth percentile, second CDF percentage 868b is a CDF percentage associated with an approximately ninety-fifth percentile, and Nth CDF percentage 868n is a CDF percentage associated with an approximately ninety-ninth percentile.

Since latency is not a stochastic measurement, a method of adding a series of values 858a-n that indicate the given probability of achieving measured latency may appear differently for each AC or TID. The AC or TID for each latency measurement may be represented in a variety of different formats. For example, for an AC, each CDF percentage 868a-n may be represented as approximately two bits of an overall field, while for each TID, each CDF percentage 868a-n may be represented as approximately four bits of an overall field. It should be appreciated that CDF percentages 868a-n provided for each AC or TID may be such that there is a predetermined order when the CDF percentages 868a-n are listed, e.g., predetermined by the order of voice (AC_VO), video (AC_VI), best effort (AC_BE), and background (AC_BK).

Multiple implementations may be used to provide latency statistics as latency CDF percentages 868a-n. For example, latency statistics providing latency CDF percentages may be represented by, but are not limited to being represented by, a single predetermined set of options defined in a standard, e.g., three CDF points at an approximately fiftieth percentile, an approximately ninety-fifth percentile, and an approximately ninety-ninth percentile as previously mentioned. Latency statistics may also be represented as a selectable set based on a pre-defined table or bitmap of options which may also be advertised in the same frame in a compact form, as for example a latency CDF bitmap of approximately four, eight, twelve, and/or sixteen bits in which each bit has a latency CDF percentile assigned. A latency CDF percentile may be included in the order of bits that are set to a value of one. For example, a four bit CDF bitmap may have bits mapped to fiftieth, ninetieth, ninety-fifth, and ninety-ninth percentiles. In one embodiment, substantially only the first three bits may be set to a value of one, and an AP may include approximately three CDF percentile values that correspond to fiftieth, ninetieth, and ninety fifth percentiles. A latency CDF percentiles may be provided dynamically in that the percentage or percentile may be returned along with the latency for at that percentile. The scheme above is also a form of a dynamic way to return a latency CDF percentile.

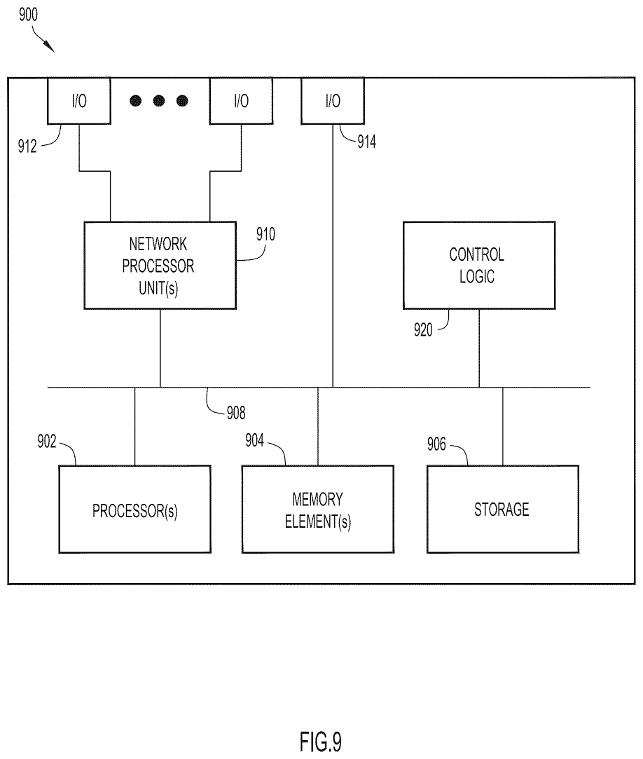

Referring next to FIG. 9, FIG. 9 illustrates a hardware block diagram of a computing device 900 that may perform functions associated with operations discussed herein in connection with the techniques depicted in FIGS. 1A, 1B, 2, 3, 4A, 4B, and 5-8. In various embodiments, a computing device or apparatus, such as computing device 900 or any combination of computing devices 900, may be configured as any entity/entities as discussed for the techniques depicted in connection with FIGS. 1A, 1B, 2, 3, 4A, 4B, and 5-8 in order to perform operations of the various techniques discussed herein.

In at least one embodiment, the computing device 900 may be any apparatus that may include one or more processor(s) 902, one or more memory element(s) 904, storage 906, a bus 908, one or more network processor unit(s) 910 interconnected with one or more network input/output (I/O) interface(s) 912, one or more I/O interface(s) 914, and control logic 920. In various embodiments, instructions associated with logic for computing device 900 can overlap in any manner and are not limited to the specific allocation of instructions and/or operations described herein.

In at least one embodiment, processor(s) 902 is/are at least one hardware processor configured to execute various tasks, operations and/or functions for computing device 900 as described herein according to software and/or instructions configured for computing device 900. Processor(s) 902 (e.g., a hardware processor) can execute any type of instructions associated with data to achieve the operations detailed herein. In one example, processor(s) 902 can transform an element or an article (e.g., data, information) from one state or thing to another state or thing. Any of potential processing elements, microprocessors, digital signal processor, baseband signal processor, modem, PHY, controllers, systems, managers, logic, and/or machines described herein can be construed as being encompassed within the broad term ‘processor’.

In at least one embodiment, memory element(s) 904 and/or storage 906 is/are configured to store data, information, software, and/or instructions associated with computing device 900, and/or logic configured for memory element(s) 904 and/or storage 906. For example, any logic described herein (e.g., control logic 920) can, in various embodiments, be stored for computing device 900 using any combination of memory element(s) 904 and/or storage 906. Note that in some embodiments, storage 906 can be consolidated with memory element(s) 904 (or vice versa), or can overlap/exist in any other suitable manner.

In at least one embodiment, bus 908 can be configured as an interface that enables one or more elements of computing device 900 to communicate in order to exchange information and/or data. Bus 908 can be implemented with any architecture designed for passing control, data and/or information between processors, memory elements/storage, peripheral devices, and/or any other hardware and/or software components that may be configured for computing device 900. In at least one embodiment, bus 908 may be implemented as a fast kernel-hosted interconnect, potentially using shared memory between processes (e.g., logic), which can enable efficient communication paths between the processes.

In various embodiments, network processor unit(s) 910 may enable communication between computing device 900 and other systems, entities, etc., via network I/O interface(s) 912 (wired and/or wireless) to facilitate operations discussed for various embodiments described herein. In various embodiments, network processor unit(s) 910 can be configured as a combination of hardware and/or software, such as one or more Ethernet driver(s) and/or controller(s) or interface cards, Fibre Channel (e.g., optical) driver(s) and/or controller(s), wireless receivers/transmitters/transceivers, baseband processor(s)/modem(s), and/or other similar network interface driver(s) and/or controller(s) now known or hereafter developed to enable communications between computing device 900 and other systems, entities, etc. to facilitate operations for various embodiments described herein. In various embodiments, network I/O interface(s) 912 can be configured as one or more Ethernet port(s), Fibre Channel ports, any other I/O port(s), and/or antenna(s)/antenna array(s) now known or hereafter developed. Thus, the network processor unit(s) 910 and/or network I/O interface(s) 912 may include suitable interfaces for receiving, transmitting, and/or otherwise communicating data and/or information in a network environment.

I/O interface(s) 914 allow for input and output of data and/or information with other entities that may be connected to computing device 900. For example, I/O interface(s) 914 may provide a connection to external devices such as a keyboard, keypad, a touch screen, and/or any other suitable input and/or output device now known or hereafter developed. In some instances, external devices can also include portable computer readable (non-transitory) storage media such as database systems, thumb drives, portable optical or magnetic disks, and memory cards. In still some instances, external devices can be a mechanism to display data to a user, such as, for example, a computer monitor, a display screen, or the like.

In various embodiments, control logic 920 can include instructions that, when executed, cause processor(s) 902 to perform operations, which can include, but not be limited to, providing overall control operations of computing device; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

The programs described herein (e.g., control logic 920) may be identified based upon application(s) for which they are implemented in a specific embodiment. However, it should be appreciated that any particular program nomenclature herein is used merely for convenience; thus, embodiments herein should not be limited to use(s) solely described in any specific application(s) identified and/or implied by such nomenclature.

In various embodiments, any entity or apparatus as described herein may store data/information in any suitable volatile and/or non-volatile memory item (e.g., magnetic hard disk drive, solid state hard drive, semiconductor storage device, random access memory (RAM), read only memory (ROM), erasable programmable read only memory (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term ‘memory element’. Data/information being tracked and/or sent to one or more entities as discussed herein could be provided in any database, table, register, list, cache, storage, and/or storage structure: all of which can be referenced at any suitable timeframe. Any such storage options may also be included within the broad term ‘memory element’ as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, digital signal processing (DSP) instructions, software [potentially inclusive of object code and source code], etc.) for execution by one or more processor(s), and/or other similar machine, etc. Generally, memory element(s) 904 and/or storage 906 can store data, software, code, instructions (e.g., processor instructions), logic, parameters, combinations thereof, and/or the like used for operations described herein. This includes memory element(s) 904 and/or storage 906 being able to store data, software, code, instructions (e.g., processor instructions), logic, parameters, combinations thereof, or the like that are executed to carry out operations in accordance with teachings of the present disclosure.

In some instances, software of the present embodiments may be available via a non-transitory computer useable medium (e.g., magnetic or optical mediums, magneto-optic mediums, CD-ROM, DVD, memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

Although only a few embodiments have been described in this disclosure, it should be understood that the disclosure may be embodied in many other specific forms without departing from the spirit or the scope of the present disclosure. By way of example, while latency information has been described as being provided as CDF information or one or more latency CDF percentiles, latency information is not limited to being provided as CDF information or latency CDF percentiles.

The information included in messages may vary, and is not limited to the information described above with respect to FIG. 7. For example, a beacon may include SSIDs for each AP included in an AP MLD, a media access control (MAC) address for the AP MLD, and basic service set identifiers (BSSIDs) associated with the APs of the AP MLD, in addition to latency information for each AP included in the AP MLD.

In some aspects, the techniques described herein relate to a method including: determining at least one latency indication associated with a network element, the at least one latency indication including a plurality of statistics indicative of a latency associated with at least a first link supported by the network element; causing the at least one latency indication to be provided in a message, the message configured to be provided to a client; and obtaining a request from the client in response to the at least one latency indication provided in the message.

In some aspects, the techniques described herein relate to a method wherein the network element is an access point multi-link device (AP-MLD) that includes a plurality of access points (APs).

In some aspects, the techniques described herein relate to a method wherein the request is a connection request which indicates whether the client has selected the first link, the plurality of APs including at least a first AP and a second AP, the first AP being associated with the first link, the method further including: establishing a connection between the first AP and the client on the first link.

In some aspects, the techniques described herein relate to a method wherein the first link is a 6 GigaHertz (GHz) link, and wherein the second AP is associated with a second link, the second link being a 5 GHz link.

In some aspects, the techniques described herein relate to a method wherein the plurality of APs includes a first AP associated with the first link and a second AP associated with a second link, and wherein determining the at least one latency indication includes determining a plurality of latency cumulative distribution function (CDF) percentiles associated with the AP-MLD, the plurality of statistics including the plurality of latency CDF percentiles.

In some aspects, the techniques described herein relate to a method wherein the plurality of CDF percentiles associated with the AP-MLD includes a latency CDF percentile for each link of the AP-MLD.

In some aspects, the techniques described herein relate to a method wherein causing the at least one latency indication to be provided in the message includes providing the plurality of statistics in the element.

In some aspects, the techniques described herein relate to a method wherein the element is defined to provide one selected from a group including the plurality of statistics and a base service set (BSS) load element.

In some aspects, the techniques described herein relate to a method further including: providing the plurality of statistics, by the network element, for one or more links of at least one neighboring AP-MLD of the AP-MLD in an element in the message.

In some aspects, the techniques described herein relate to a method wherein the element is one selected from a group including a neighbor report (NR) element and a reduced neighbor report (RNR) element.

In some aspects, the techniques described herein relate to a method further including: determining, by the client, a first AP-MLD of the at least one neighboring AP-MLD using the at least one latency indication from the message.

In some aspects, the techniques described herein relate to a method wherein the plurality of CDF percentiles includes latency CDF percentiles for at least one traffic identifiers (TID).

In some aspects, the techniques described herein relate to a method wherein the plurality of CDF percentiles includes latency CDF percentiles provided for one or more Wi-Fi routers supported for 802.11ac.

In some aspects, the techniques described herein relate to a method wherein the message is one selected from a group including a beacon, a probe response, a fast initial link setup (FILS) discovery frame, a neighbor report response frame, an association response frame, a reassociation response frame, a roaming response frame, an fast base service set (BSS) response frame,, and a BSS transmission management (BTM) request.

In some aspects, the techniques described herein relate to a method wherein the request is a request to add the first link.

In some aspects, the techniques described herein relate to a method wherein the request is a request to obtain traffic on the first link.

In some aspects, the techniques described herein relate to an apparatus including: a first network element, the first network element being associated with a first link; a second network element; a processor; logic, when executed by the processor, operable to (i) determine at least one latency indication associated with at least one of the first network element and the second network element, the at least one latency indication including a plurality of statistics indicative of a latency associated with at least the first link, and (ii) cause the at least one latency indication to be provided in a message, the message configured to be provided to a client; and a communications arrangement, the communications arrangement configured to obtain a connection request from the client in response to the at least one latency indication.

In some aspects, the techniques described herein relate to an apparatus wherein the first network element is a first access point (AP), and the second network element is a second AP.

In some aspects, the techniques described herein relate to an apparatus wherein the second AP is associated with a second link, and wherein the first link is a 6 GigaHertz (GHz) and the second link is a 5 GHz link.

In some aspects, the techniques described herein relate to an apparatus wherein the logic configured to determine the at least one latency indication includes logic operable to determine a plurality of latency cumulative distribution function (CDF) percentiles associated with the first AP and the second AP, the plurality of statistics including the plurality of latency CDF percentiles.

In some aspects, the techniques described herein relate to an apparatus wherein the logic configured to cause the at least one latency indication to be provided in the message includes logic configured to define an element in the message and logic configured to provide the plurality of statistics in the element.

In some aspects, the techniques described herein relate to an apparatus wherein the message is one selected from a group including a beacon, a probe response, a fast initial link setup (FILS) discovery frame, a neighbor report response frame, an association response frame, a reassociation response frame, a roaming response frame, an fast base service set (BSS) response frame,, and a BSS transmission management (BTM) request.

In some aspects, the techniques described herein relate to an apparatus wherein the request is a request to add the first link.

In some aspects, the techniques described herein relate to an apparatus wherein the request is a request to obtain traffic on the first link.

In some aspects, the techniques described herein relate to one or more non-transitory computer readable storage media encoded with instructions, that when executed by a processor, cause the processor to perform: determining at least one latency indication associated with a network element, the at least one latency indication including a plurality of statistics indicative of a latency associated with at least a first link supported by the network element; causing the at least one latency indication to be provided in a message, the message configured to be provided to a client; obtaining a request from the client in response to the at least one latency indication.

In some aspects, the techniques described herein relate to one or more non-transitory computer readable storage media wherein the network element is an access point multi-link device (AP-MLD) that includes a plurality of access points (APs).

In some aspects, the techniques described herein relate to one or more non-transitory computer readable storage media wherein the request is a connection request which indicates whether the client has selected the first link, the plurality of APs including at least a first AP and a second AP, the first AP being associated with the first link, and wherein the instructions further cause the processor to perform: establishing a connection between the first AP and the client on the first link.

In some aspects, the techniques described herein relate to one or more non-transitory computer readable storage media wherein the first link is a 6 GigaHertz (GHz) link, and wherein the second AP is associated with a second link, the second link being a 5 GHz link.

In some aspects, the techniques described herein relate to one or more non-transitory computer readable storage media wherein the plurality of APs includes a first AP associated with the first link and a second AP associated with a second link, and wherein determining the at least one latency indication includes determining a plurality of latency cumulative distribution function (CDF) percentiles associated with the AP-MLD, the plurality of statistics including the plurality of latency CDF percentiles.

In some aspects, the techniques described herein relate to one or more non-transitory computer readable storage media wherein causing the at least one latency indication to be provided in the message includes defining an element in the message and providing the plurality of statistics in the element.

In some aspects, the techniques described herein relate to one or more non-transitory computer readable storage media wherein the request is a request to add the first link.

In some aspects, the techniques described herein relate to one or more non-transitory computer readable storage media wherein the request is a request to obtain traffic on the first link.

### Variations and Implementations

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any local area network (LAN), virtual LAN (VLAN), wide area network (WAN) (e.g., the Internet), software defined WAN (SD-WAN), wireless local area (WLA) access network, wireless wide area (WWA) access network, metropolitan area network (MAN), Intranet, Extranet, virtual private network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/nG, IEEE 802.11 (e.g., Wi-Fi®/Wi-Fi 6®), IEEE 802.16 (e.g., Worldwide Interoperability for Microwave Access (WiMAX)), Radio-Frequency Identification (RFID), Near Field Communication (NFC), Bluetooth™, mm.wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may be directly or indirectly connected utilizing any algorithms, communication protocols, interfaces, etc. (proprietary and/or non-proprietary) that allow for the exchange of data and/or information.

Communications in a network environment can be referred to herein as ‘messages’, ‘messaging’, ‘signaling’, ‘data’, ‘content’, ‘objects’, ‘requests’, ‘queries’, ‘responses’, ‘replies’, etc. which may be inclusive of packets. As referred to herein and in the claims, the term ‘packet’ may be used in a generic sense to include packets, frames, segments, datagrams, and/or any other generic units that may be used to transmit communications in a network environment. Generally, a packet is a formatted unit of data that can contain control or routing information (e.g., source and destination address, source and destination port, etc.) and data, which is also sometimes referred to as a ‘payload’, ‘data payload’, and variations thereof. In some embodiments, control or routing information, management information, or the like can be included in packet fields, such as within header(s) and/or trailer(s) of packets. Internet Protocol (IP) addresses discussed herein and in the claims can include any IP version 4 (IPv4) and/or IP version 6 (IPv6) addresses.

To the extent that embodiments presented herein relate to the storage of data, the embodiments may employ any number of any conventional or other databases, data stores or storage structures (e.g., files, databases, data structures, data or other repositories, etc.) to store information.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments. Note also that a module, engine, client, controller, function, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of’, ‘one or more of’, ‘and/or’, variations thereof, or the like are open-ended expressions that are both conjunctive and disjunctive in operation for any and all possible combination of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Each example embodiment disclosed herein has been included to present one or more different features. However, all disclosed example embodiments are designed to work together as part of a single larger system or method. This disclosure explicitly envisions compound embodiments that combine multiple previously-discussed features in different example embodiments into a single system or method.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of’ and ‘one or more of’ can be represented using the ‘(s)’ nomenclature (e.g., one or more element(s)).

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

What is claimed is:

1. A method comprising:
determining at least one latency indication associated with a network element, the at least one latency indication including a plurality of statistics indicative of a latency associated with at least a first link supported by the network element;
causing the at least one latency indication to be provided in a message, the message configured to be provided to a client; and
obtaining a request from the client in response to the at least one latency indication provided in the message.

2. The method of claim 1 wherein the network element is an access point multi-link device (AP-MLD) that includes a plurality of access points (APs).

3. The method of claim 2 wherein the request is a connection request which indicates whether the client has selected the first link, the plurality of APs including at least a first AP and a second AP, the first AP being associated with the first link, the method further including:
establishing a connection between the first AP and the client on the first link.

4. The method of claim 3 wherein the first link is a 6 GigaHertz (GHz) link, and wherein the second AP is associated with a second link, the second link being a 5 GHz link.

5. The method of claim 2 wherein the plurality of APs includes a first AP associated with the first link and a second AP associated with a second link, and wherein determining the at least one latency indication includes determining a plurality of latency cumulative distribution function (CDF) percentiles associated with the AP-MLD, the plurality of statistics including the plurality of latency CDF percentiles.

6. The method of claim 5 wherein the plurality of CDF percentiles associated with the AP-MLD includes a latency CDF percentile for each link of the AP-MLD.

7. The method of claim 5 wherein causing the at least one latency indication to be provided in the message includes providing the plurality of statistics in the element.

8. The method of claim 7 wherein the element is defined to provide one selected from a group including the plurality of statistics and a base service set (BSS) load element.

9. The method of claim 7 further comprising:
providing the plurality of statistics, by the network element, for one or more links of at least one neighboring AP-MLD of the AP-MLD in an element in the message.

10. The method of claim 9 wherein the element is one selected from a group including a neighbor report (NR) element and a reduced neighbor report (RNR) element.

11. The method of claim 10 further including:
determining, by the client, a first AP-MLD of the at least one neighboring AP-MLD using the at least one latency indication from the message.

12. The method of claim 5 wherein the plurality of CDF percentiles includes latency CDF percentiles for at least one traffic identifiers (TID).

13. The method of claim 5 wherein the plurality of CDF percentiles includes latency CDF percentiles provided for one or more Wi-Fi routers supported for IEEE 802.11ac access category.

14. The method of claim 7 wherein the message is one selected from a group including a beacon, a probe response, a fast initial link setup (FILS) discovery frame, a neighbor report response frame, an association response frame, a reassociation response frame, a roaming response frame, a fast base service set (BSS) response frame, and a BSS transmission management (BTM) request.

15. The method of claim 1 wherein the request is a request to add the first link.

16. The method of claim 1 wherein the request is a request to obtain traffic on the first link.

17. An apparatus comprising:
a first network element, the first network element being associated with a first link;
a second network element;
a processor;
logic, when executed by the processor, operable to
(i) determine at least one latency indication associated with at least one of the first network element and the second network element, the at least one latency indication including a plurality of statistics indicative of a latency associated with at least the first link, and
(ii) cause the at least one latency indication to be provided in a message, the message configured to be provided to a client; and
a communications arrangement, the communications arrangement configured to obtain a connection request from the client in response to the at least one latency indication.

18. The apparatus of claim 17 wherein the first network element is a first access point (AP), and the second network element is a second AP.

19. The apparatus of claim 18 wherein the second AP is associated with a second link, and wherein the first link is a 6 GigaHertz (GHz) and the second link is a 5 GHz link.

20. The apparatus of claim 18 wherein the logic configured to determine the at least one latency indication includes logic operable to determine a plurality of latency cumulative distribution function (CDF) percentiles associated with the first AP and the second AP, the plurality of statistics including the plurality of latency CDF percentiles.

21. The apparatus of claim 20 wherein the logic configured to cause the at least one latency indication to be provided in the message includes logic configured to define an element in the message and logic configured to provide the plurality of statistics in the element.

22. The apparatus of claim 21 wherein the message is one selected from a group including a beacon, a probe response, a fast initial link setup (FILS) discovery frame, a neighbor report response frame, an association response frame, a reassociation response frame, a roaming response frame, a fast base service set (BSS) response frame, and a BSS transmission management (BTM) request.

23. The apparatus of claim 17 wherein the request is a request to add the first link.

24. The apparatus of claim 17 wherein the request is a request to obtain traffic on the first link.

25. One or more non-transitory computer readable storage media encoded with instructions, that when executed by a processor, cause the processor to perform:
determining at least one latency indication associated with a network element, the at least one latency indication including a plurality of statistics indicative of a latency associated with at least a first link supported by the network element;
causing the at least one latency indication to be provided in a message, the message configured to be provided to a client;
obtaining a request from the client in response to the at least one latency indication.

26. The one or more non-transitory computer readable storage media of claim 25 wherein the network element is an access point multi-link device (AP-MLD) that includes a plurality of access points (APs).

27. The one or more non-transitory computer readable storage media of claim 26 wherein the request is a connection request which indicates whether the client has selected the first link, the plurality of APs including at least a first AP and a second AP, the first AP being associated with the first link, and wherein the instructions further cause the processor to perform:
establishing a connection between the first AP and the client on the first link.

28. The one or more non-transitory computer readable storage media of claim 27 wherein the first link is a 6 GigaHertz (GHz) link, and wherein the second AP is associated with a second link, the second link being a 5 GHz link.

29. The one or more non-transitory computer readable storage media of claim 27 wherein the plurality of APs includes a first AP associated with the first link and a second AP associated with a second link, and wherein determining the at least one latency indication includes determining a plurality of latency cumulative distribution function (CDF) percentiles associated with the AP-MLD, the plurality of statistics including the plurality of latency CDF percentiles.

30. The one or more non-transitory computer readable storage media of claim 29 wherein causing the at least one latency indication to be provided in the message includes defining an element in the message and providing the plurality of statistics in the element.

31. The one or more non-transitory computer readable storage media of claim 25 wherein the request is a request to add the first link.

32. The one or more non-transitory computer readable storage media of claim 25 wherein the request is a request to obtain traffic on the first link.
